(19) United States
(12) Patent Application Publication
(10) Pub. No.: US 2026/0116675 A1
(43) Pub. Date: Apr. 30, 2026

(54) STAR WHEEL DRIVE SYSTEMS

(71) Applicant: JBT Marel Corporation, Chicago, IL (US)

(72) Inventors: Cezary J. Mroz, Lewis Center, OH (US); Wyatt W. Wills, Newark, OH (US); Kristen Rose Mason, Mentor, OH (US)

(73) Assignee: JBT Marel Corporation, Chicago, IL (US)

(21) Appl. No.: 19/358,177

(22) Filed: Oct. 14, 2025

Related U.S. Application Data
(60) Provisional application No. 63/713,740, filed on Oct. 30, 2024.

(51) Int. Cl. B65G 47/84

(52) U.S. Cl. CPC B65G 47/846; B65G 2201/0244; B65G 2201/0252; B65G 2811/091

(57) ABSTRACT

A self-contained drive system for feeding containers to a processing station and for removing containers from the processing station. The drive system includes a housing constructed structurally separate from and positioned relative to the processing station and a drive train insertable as a unit into the housing. The drive train includes a rotatable drive head for feeding containers to and from the processing station, a servo motor linked to the drive head for rotating the drive head and a mounting member for detachably mounting the drive train to the housing as single unit.

### CROSS-REFERENCE TO RELATED APPLICATION

This application claims the benefit of U.S. Provisional Application No. 63/713,740, filed Oct. 30, 2024, the entire contents of which are incorporated herein by reference.

### BACKGROUND

Containers are commonly fed to a processing station or apparatus one at a time for filling the container, for degassing the container, for sealing the container or for other purposes. The processing station may have a carrousel on to which the container is received for processing. Correspondingly, the filled, degassed, or sealed containers are removed from the processing station carrousel for subsequent operations. The feeding of the containers to the processing station and removal of the containers from the processing station is commonly carried out with a star wheel drive system located adjacent the processing station. Such star wheel drive systems commonly include an indexing wheel having pockets shaped and sized to receive the container and move the containers onto the processing station carrousel and remove the containers from the processing station carrousel.

Star wheel drive systems require maintenance and also may need to be repaired if a failure of the drive system occurs. Disassembly of the star wheel drive system is typically a time consuming task, wherein the drive system is removed or disassembled component by component. Reassembly of the star wheel drive system is likewise a time-consuming, component-by-component operation. The present disclosure seeks to address this limitation of current star wheel drive systems as well as drive systems in general.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a self-contained drive system is provided for feeding containers to a processing station and for removing containers from a processing station. The drive system includes a housing that is constructed structurally separate from and positioned relative to the processing station, a drive train insertable as a unit into the housing, the drive train comprising a rotatable drive head for feeding containers to the processing station and for removing containers from a processing station, a servo motor linked to the drive head for rotating the drive head, and a mounting member for detachably mounting the drive train to the housing as unit.

In any of the embodiments described herein, wherein the housing is elongated in the upright direction to receive the drive train therein.

In any of the embodiments described herein, wherein the housing comprising an upper opening for receiving the drive train into the housing.

In any of the embodiments described herein, wherein the servo motor is rigidly attached to the mounting member with a mounting structure extending from the mounting member to the servo motor.

In any of the embodiments described herein, further comprising a drive shaft extending between the drive head and the servo motor.

In any of the embodiments described herein, further comprising a gear assembly interposed between the drive shaft and the servo motor.

In any of the embodiments described herein, wherein the gear assembly is attached to the drive shaft with a coupling that accommodates misalignment between the gear assembly and the drive shaft.

In any of the embodiments described herein, wherein the drive train includes a bearing assembly positioned between the driveshaft and the mounting structure.

In any of the embodiments described herein, wherein the bearing assembly comprises two spaced apart bearings.

In any of the embodiments described herein, wherein the bearings comprise radial thrust bearings.

In any of the embodiments described herein, wherein the housing is generally in the form of an upright cylinder.

In any of the embodiments described herein, wherein the drive head is adapted to receive at least one indexing wheel shaped to feed containers to the processing station and remove containers from the processing station.

In any of the embodiments described herein, wherein the indexing wheel includes pockets for receiving the containers to be fed to the processing station and from receiving containers for removal from the processing station.

In any of the embodiments described herein, further comprising a control system for controlling the operation of the servo motor to rotate the drive head in a desired direction and at a desired speed.

In accordance with one embodiment of the present disclosure, a drive train constructed as a singular unit is provided for powering a work piece transfer system. The drive train includes a rotatable drive head, a servo motor, a drive shaft linking the drive head to the servo motor, a mounting member for mounting the drive train to an operating location of the drive train, and a rigid mounting structure for mounting the servo motor to the mounting member.

In any of the embodiments described herein, further comprising a gear assembly interposed between the drive shaft and the servo motor.

In any of the embodiments described herein, further comprising at least one bearing assembly interposed between the drive shaft and the mounting structure.

In any of the embodiments described herein, wherein the drive head is configured to be connected to at least one star wheel configured for receiving and transferring work pieces.

In any of the embodiments described herein, adapted for connection to a control system for controlling the operation of the servo motor to rotate the drive head in a desired direction and at a desired speed.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial view of a prior art star wheel drive system;

FIG. 2 is a pictorial view of the star wheel drive system of FIG. 1 with portions of the housing removed so that components of the drive system are visible;

FIG. 3 an elevational view of a star wheel drive system of the present disclosure show in conjunction with a processing station in the form of a beverage filler;

FIG. 4 is a pictorial view of the star wheel drive system of FIG. 3;

FIG. 5 is a pictorial view of the star wheel drive train shown removed as a single unit from a housing;

FIG. 6 is a view similar to FIG. 5, with the star wheels removed;

FIG. 7 is cross-section view of the star wheel drive system of FIG. 4;

FIG. 8 is an enlarged fragmentary view of the lower portion of FIG. 5.

### DETAILED DESCRIPTION

Various example embodiments of the present disclosure are described below with reference to the accompanying drawings in which some example embodiments are illustrated. In the figures, the thicknesses of lines, layers and/or regions may be exaggerated for clarity.

While example embodiments are capable of various modifications and alternative forms, embodiments thereof are shown by way of example in the figures and are described in detail below. It should be understood, however, that there is no intent to limit example embodiments to the particular forms disclosed, but on the contrary, example embodiments are to cover all modifications, equivalents, and alternatives falling within the scope of the disclosure.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be considered in the specific context this definition is given herein.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. Further, it will be appreciated that embodiments of the present disclosure may employ any combination of features described herein.

The present application may include references to directions, such as “forward,” “rearward,” “front,” “back,” “ahead,” “behind,” “upward,” “downward,” “above,” “below,” “top,” “bottom,” “right hand,” left hand,” “in,” “out,” “extended,” “advanced,” “retracted,” “proximal,” “distal,” “central,” “vertical,” etc. These references and other similar references in the present application are only to assist in helping describe and understand the present invention and are not intended to limit the present invention to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc.

The present application may include modifiers such as the words “generally,” “approximately,” “about”, or “substantially.” These terms are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out. If a quantitative value is needed to render the applicable parameter sufficiently definite, the applicable parameter is within five percent (5%) of the designated parameter value.

In the following description, various embodiments of the present disclosure are described. In the following description and in the accompanying drawings, the corresponding systems assemblies, apparatus, and units may be identified by the same part number, but with an alpha suffix or by a prime (“′”) or double prime (“″”) or even a triple prime (“′″”) designation. The descriptions of the parts/components of such systems assemblies, apparatus, and units that are the same or similar are not repeated so as to avoid redundancy in the present application.

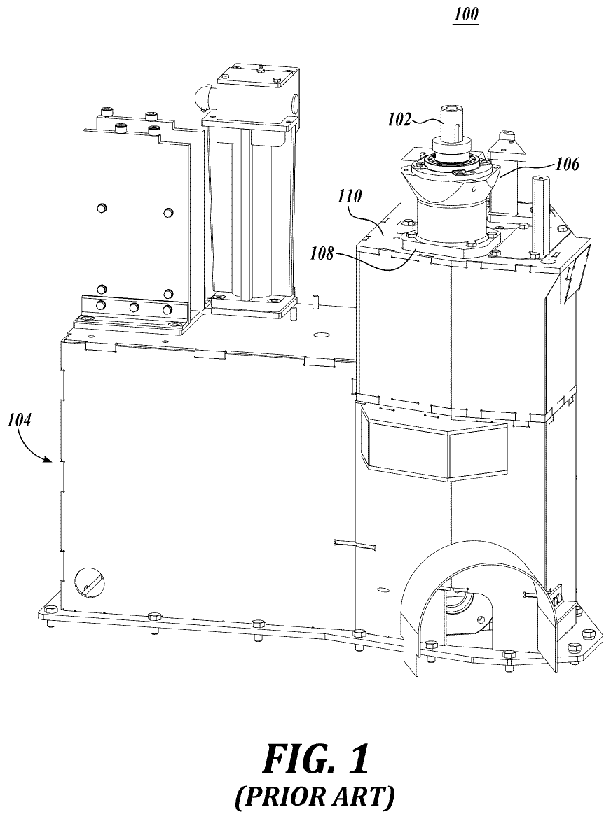

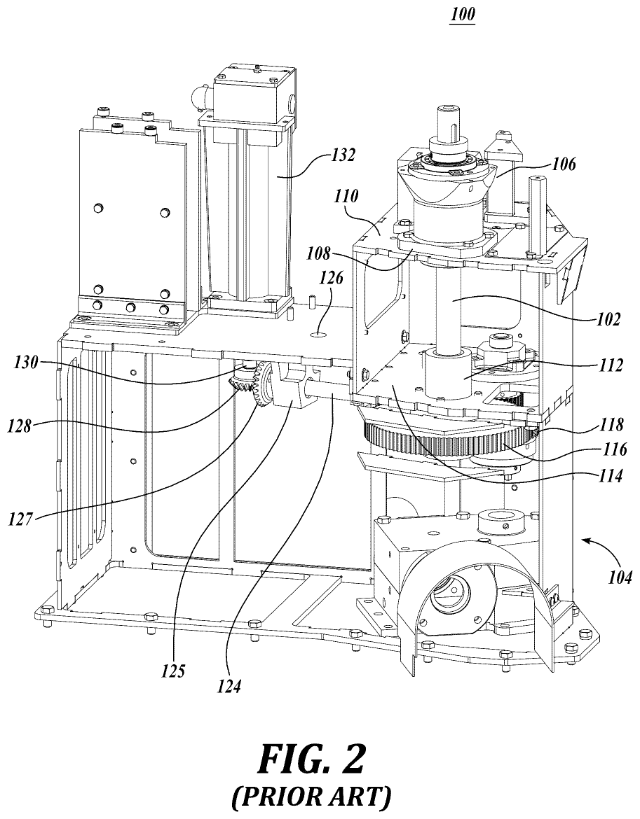

FIGS. 1 and 2 show an existing star wheel drive system 100, wherein a drive shaft 102 extends upward out of a housing 104. The drive shaft 102 is adapted to receive one or two star wheels, not shown. The drive shaft 102 extends downwardly through a bearing assembly 106 that supports the drive shaft in both radial and axial directions. The bearing assembly 106 has a mounting flange 108 that is bolted to the top panel 110 of the housing 104.

From the bearing assembly 106, the drive shaft 102 extends downwardly into the housing 104 through a radial collar 112 mounted to a horizontal panel 114 of the housing 104. The lower end of the drive shaft 102 is attached to a larger driven gear 116, which in turn is driven by a smaller drive gear 118. The smaller drive gear 118 is mounted on a jack shaft 119 to which is also mounted a larger bevel gear 120. The larger bevel gear 120 is driven by a smaller bevel gear 122 mounted on a horizontal shaft 124 disposed ninety degrees to the drive shaft 102.

The horizontal shaft 124 is supported in part by a bracket 125 suspended underneath housing panel 126. Another bevel gear 127 is mounted to the opposite end of the horizontal shaft 124. The further bevel gear 128 mounted on the bottom end of a vertical shaft 130 to mesh with the bevel gear 127. The vertical shaft 130 is driven by a rotatable actuator 132 extending upwardly from the housing panel 126.

As can be appreciated, a significant amount of disassembly is required to service or repair the drive system 100. During the service or repair process, the star wheel drive system 100 is off line, and is not operating to deliver containers to or remove containers from a processing station.

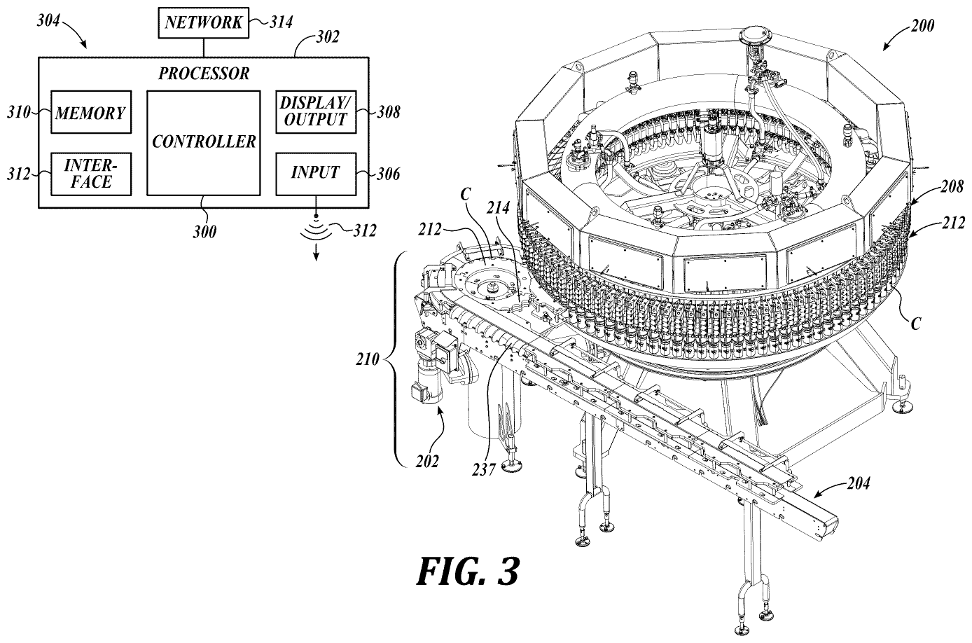

FIG. 3 depicts an exemplary processing station according to the present disclosure in the form of a high-speed beverage filling machine 200 that may be used with an indexing wheel drive system 202 of the present disclosure. In basic form, the filler machine 200 includes a frame 204 for supporting a revolving or rotary filling system having a rotating carriage 206 that revolves around a central, vertical carriage axis. The rotating carriage 206 is designed to receive and hold bottles or cans C as shown for filling at a plurality of filling positions located about the periphery of the rotating carriage 206. At each of the filling positions is located a filling arrangement 208 having at least one filling device, element, apparatus, valve, etc., in communication with a beverage supply. The filling arrangements 208 are designed to introduce a predetermined volume or amount of liquid beverage into the interior of the cans C or fill the cans to a predetermined or desired level.

The high-speed beverage filling machine 200 includes an infeed assembly 210 that is configured to transition a bulk supply of empty containers C (such as from an infeed table or beverage packaging) to an organized, continuous supply of singulated empty containers C. The infeed assembly 210 may include an indexing wheel drive system 202 that powers one or more indexing wheels that may be in the form of star wheels 212 shaped to receive a single empty container C, such as a can, in individual pockets 214 formed or defined around the circumference of the star wheels 212. The empty containers C are moved about the periphery of the star wheels 212, typically against a counter force of one or more guide rails, and transported to the carriage 206 or to another portion of the filling machine 200.

The exemplary, representative high-speed beverage filling machine 200 includes an infeed assembly 210, shown in isolation in FIG. 3. In the depicted example, the infeed assembly 210 is configured, at least in part, as a motorized drive system 202 and upper and lower star wheels 212 powered by the drive system. Each of the upper and lower star wheels 212 have circumferential, aligned container pockets 214 that each receive a single empty container, such as a can C. The upper and lower star wheels 212 rotate in unison to feed singulated, empty cans C to the rotating carriage 206 of the rotary filling machine for carrying out the filling process.

An outfeed assembly for a processing system, such as the high-speed beverage filling machine 200, may include similar components to the infeed assembly 210 configured to transport or more filled containers from the filling machine to a downstream machine or station, such as a container closure machine. The container closure machine may be a can seamer, a bottle capping machine, etc. The container closure machine may similarly include infeed and outfeed assemblies configured to transport filled containers to and from the machine. These infeed and outfeed assemblies may be in the form of assembly 210.

It can be appreciated that the pocket size and/or shape of the upper and lower star wheels 212 is specific to the size and/or type of container. In that regard, when the container size and/or type needs to be changed, such as for a new production run, the upper and lower star wheels 212 may also need to be changed. Moreover, the upper and lower star wheels 212 periodically need to be changed due to wear and tear. The star wheels 212 rotate at high speeds for extended periods of time leading to eventual wear. Wear and tear of the star wheels 212 can cause the infeed assembly 210 to malfunction, for example to not feed the cans C properly to the rotating carriage 206.

In addition, the components of the drive system 202, described below, need to be periodically serviced and/or replaced If a failure in the drive system occurs, it is necessary to disassemble the drive system for repair. The drive system 202 of the present disclosure is designed to facilitate servicing and/or repair.

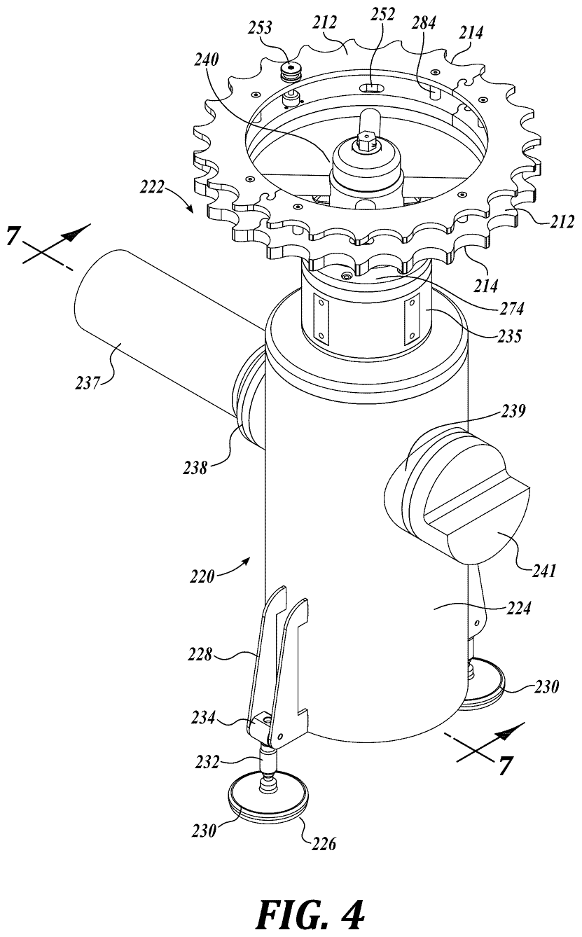

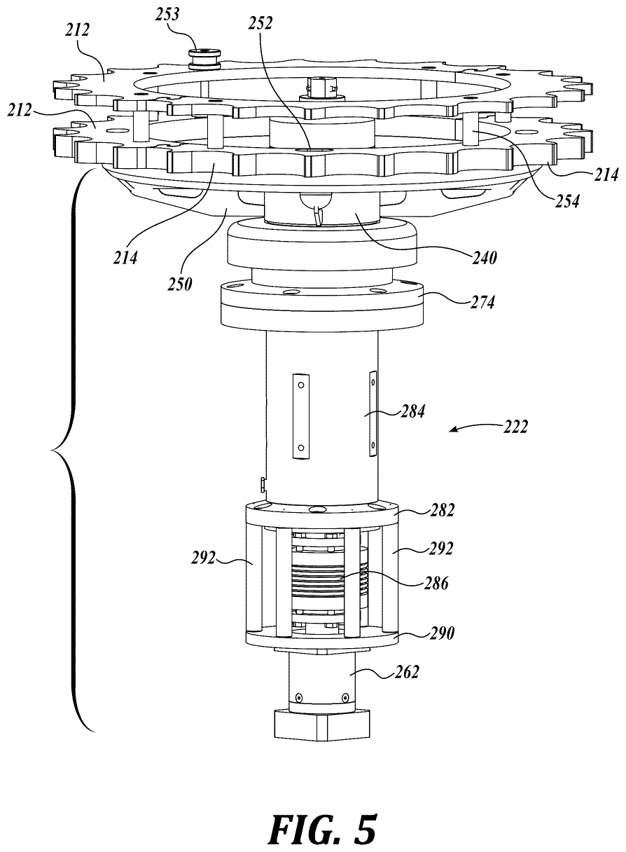

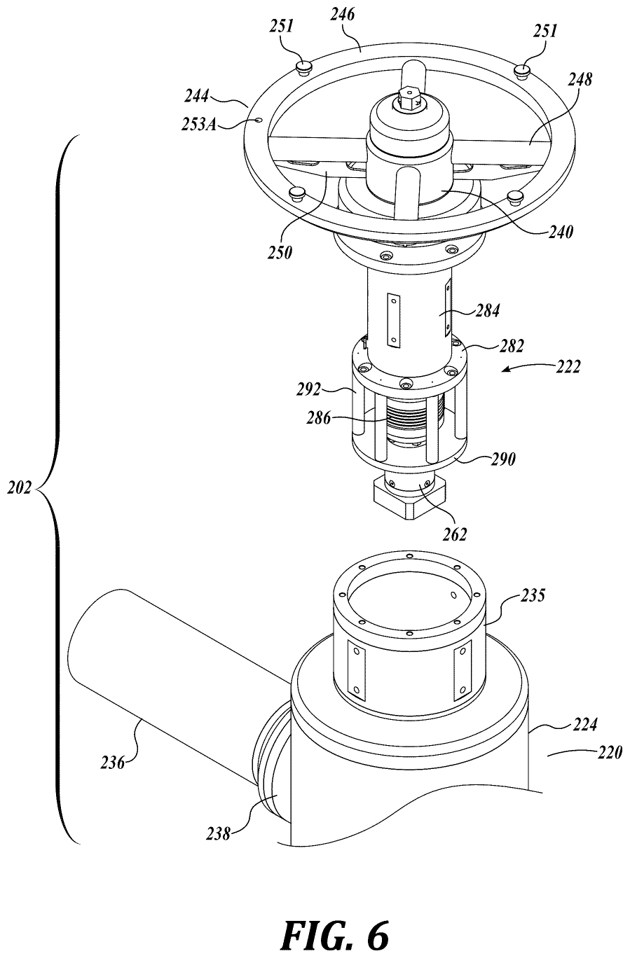

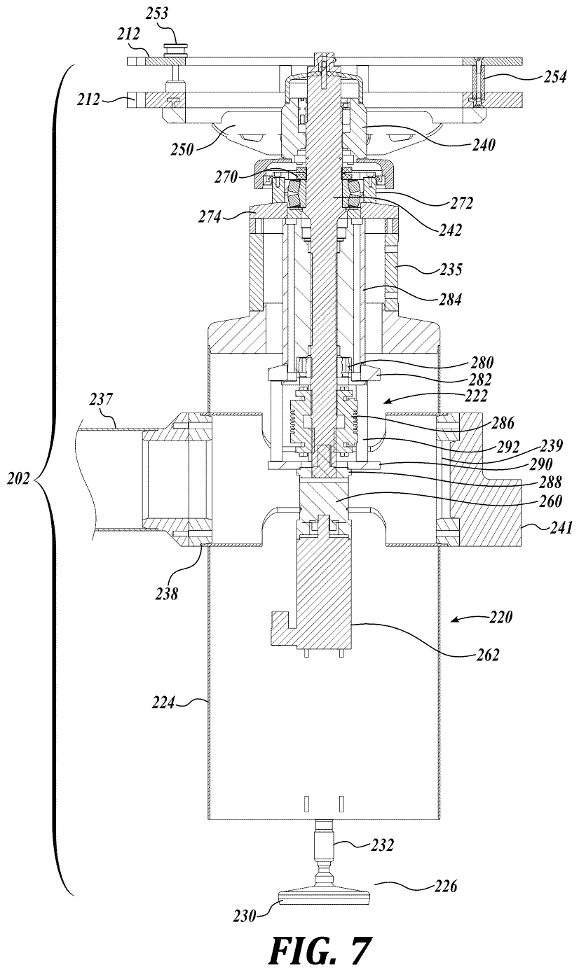

The drive system 202, as shown in FIGS. 3-7, in basic form includes a housing assembly 220 and a drive train 222 for driving the star wheels 212. The drive train 222 is constructed as a single, standalone unit. This enables the drive train 222 to be placed into the housing assembly 220 as a single unit, and likewise enables the drive train 222 to be removed from the housing assembly 220 as a single unit. In this manner, a replacement drive train can placed into the housing assembly 220 while the removed drive train is serviced and/or repaired. As such, minimal down time of the beverage filling machine 200 or other processing machine or station occurs.

Referring primarily to FIGS. 3, 4, 6, and 7, the housing assembly 220 includes an upright housing 224 that may be cylindrical in shape. Adjustable feet units 226 are mounted to the lower exterior of the housing by brackets 228 affixed to the housing. The feet units include circular pad 230 and a threaded shaft 232 extending upwardly from the pad to engage threaded nut 234 that is pivotally mounted to the lower portion of the bracket. In this manner the pad maintains full contact with the floor or other surface on which the beverage filling machine is located.

A cylindrical hub 235 is attached to the top 236 of the housing 224. The hub centers the drive train 222 relative to the housing assembly 220 and is the location where the drive train in attached to the housing assembly, see below.

The housing assembly 220, and thus the infeed assembly 210, is located relative to the filling machine 200 via a connection tube 237 that extends radially from the filling machine frame 204 to connect to the housing 224 at a connection flange 238. The connection tube 237 provides a pathway for electrical lines or other lines to reach the drive system 202. Of course, other means can be used to position the infeed assembly 210 relative to the filling machine 200.

As noted above, the drive train 222 is constructed as a single, stand-alone unit. In this regard, the drive train 222 includes a drive head 240 mounted to the upper end of an upright or vertical drive shaft 242. A drive wheel 244 is mounted to the drive head 240. The drive wheel 244 includes a circular drive rim 246 that is connected to the drive head via spokes 248. A reinforcing web 250 may be located below the spokes 248 to add strength and rigidity to the drive wheel 244.

Two star wheels 212 are mounted to the drive wheel 244. The lower star wheel is attached to the drive wheel 244. In one form of such attachment, mushroom pins 251 are mounted to the top of the drive wheel to extend upwardly therefrom. The pins 251 extend through slots 252 formed in the lower star wheel 212. The slots have enlarged end through which the heads of the pins pass though and narrower end that forms a ledge for positioning under the heads of the pin 251 when the lower star wheel is rotated relative to the drive wheel 244.

The upper star wheel 212 can be mounted to the lower using spacers 254. As such, the upper and lower star wheels 212 can be conveniently assembled to and removed from the drive wheel 244 as a single unit.

When the two star wheels 212 are assembled to the drive wheel, a pin 253 is engaged downwardly through aligned holes in the two star wheels to engage into a threaded hole 253A formed in the rim 246 of the drive wheel 244.

Although two star wheels 212 are shown in the figures, a single star wheel may be sufficient. Or, there may be the need for more than two star wheels. As such, the present disclosure is not limited to the use of the two star wheels shown in the figures.

The lower end of the drive shaft is connected to a gear box 260, which in turn is connected to a servo motor 262. In one embodiment of the present disclosure, the gear box reduces the output speed of the servo motor a ratio of about forty-to-one. Of course, depending on various factors such as, for example, the nominal speed of the servo motor and the desired speed range of the star wheels, the speed reduction provided by the gear box may be selected. To achieve the speed reduction needed while minimizing its size, the gear box may be in the form of a planetary gear system. However other gear arrangements can also be used.

A bellows coupling 286 is engaged over and attached to a lower portion of the drive shaft 242 to couple the draft shaft to the output of the gearbox 260. The bellows coupling is capable of accommodating some misalignment of the drive shaft 242 relative to the output shaft of the gearbox 260.

An upper radial trust bearing 270 is engaged with an upper portion of the drive shaft 242 to support and stabilize the drive shaft. The outer race of the bearing 270 seats within a collar 272 and an underlying attachment or seal ring 274. The attachment ring 274 functions as a mounting member to mount the drive train 222 to the top of the hub 235 that extends upwardly from housing 224.

A lower radial thrust bearing 280 engages over a lower portion of the drive shaft 242 to radially locate the drive shaft 244 relative to an upper hub plate 282 which is attached to the bottom of a connector tube 284. The upper end of the connector tube is attached to underside of the attachment ring 274.

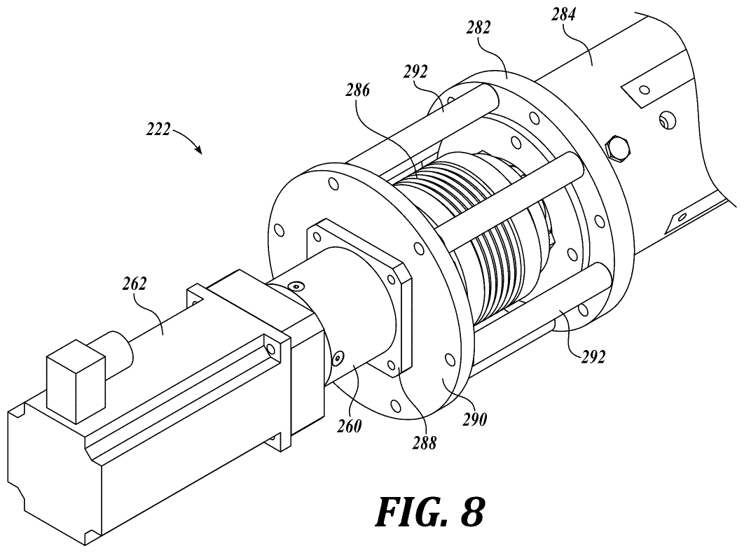

Referring also to FIG. 8, the upper end of the gear box 260 is bolted or otherwise attached to a mounting plate 288, which in turn is bolted or otherwise attached to a lower hub plate 290. The lower hub plate 290 is attached to the upper hub plate 282 by a series of spacer bars 292 to form a connection or coupling cage to mount the gearbox 260 servo motor 262 to the connector tube 284.

It will be appreciated that the connection cage, connection tube 284 and attachment ring 274 for a rigid mounting structure for the servo motor 262 and the gear box 260.

Further, by the above construction of the drive train 222, it can be appreciated that the drive train is constructed as a singular unit. Thus, the entire drive train 222 is inserted into the housing assembly 220 and removed from the housing assembly as a single unit. This is advantageous when servicing and/or repairing the drive train. The upper bearings 270 and the lower bearing 280 require maintenance and service. Also, it is possible that the bearings will need replacement due to simply reaching the end of their service life or due to failure.

Also, it may the that the gear box 260 and/or the servo motor will require servicing or repair. In addition, these components may need to be replaced due to failure or due to reaching the ends of their service lives.

As noted herein, the drive system 202 may also be used to remove containers C from a beverage filling machine. Further the same drive system 202 may be used to feed filled containers C to a lidding machine to place lids or tops on the containers. In addition, the same drive system can be used to remove the completed container from the lidding machine. Further the same drive system 202 can be used for other purposes pertaining to the filling machine 200. Although several drive systems 202 are utilized with the filling machine, only one extra drive system need be kept on hand to replace a drive system that requires servicing or repair.

The beverage filling machine 200 and indexing wheel drive system 202 are coupled to and controlled by a controller 300 operated by a processor 302 of a processing system 304, as schematically shown in FIG. 3. The processing system 304 includes an input device 306 (keyboard, mouse, touchpad, touch screen, etc.) and an output device 308 (monitor, printer, touch screen, etc.). The interface for the input and output may be the same touch screen system.

The processing system 304 also includes a memory unit 310 and an interface 312 for receiving signals and information from the filling machine 200, the indexing wheel drive system 202, as well as from other data sources related to the operation of the filling machine 200 and the indexing wheel drive system 202. The processor 302 may be connected to a network 314. Also, rather than employing a local processor 302, a network computing system can be used for this purpose.

The processing system 304 may be hard wired to the beverage filling machine 200 and indexing wheel drive system 202, or may be connected by wireless connection system 312.

It is to be understood that although a complete drive system 202 has been described herein, the present invention need not require the complete drive system, rather separate aspects of the drive system may constitute individual inventions as specified in the claims herein or in future claims to be presented.

While illustrative embodiments have been illustrated and described, it will be appreciated that various changes can be made therein without departing from the spirit and scope of the invention. In this regard, the indexing wheel drive system of the present disclosure can be used with other types of processing machines or systems beyond beverage filling machines. For example, the indexing wheel drive system of the present disclosure can be used in conjunction with a manufacturing process where work products are presented to and/or removed from a machine the performs a manufacturing process on the work products. Such manufacturing processes can be of a myriad of types, such as stamping, welding, forming, bending, grinding, boring, drilling, labeling, wrapping, date stamping, printing serial numbers, etc.

As another example, rather than utilizing a housing that is separate from the processing machine or other machine with which the infeed assembly is associated, the drive train of the present disclosure can be incorporated into the processing machine or other machine. In this regard, the drive train can be mounted on the processing machine or other machine housing or enclosure.

The embodiments of the invention in which an exclusive property or privilege is claimed are defined as follows:

1. A self-contained drive system for feeding containers to a processing station and for removing containers from a processing station, the drive system comprising:
a housing constructed structurally separate from and positioned relative to the processing station; and
a drive train insertable as a unit into the housing, the drive train comprising a rotatable drive head for feeding containers to the processing station and for removing containers from a processing station, a servo motor linked to the drive head for rotating the drive head, a mounting member for detachably mounting the drive train to the housing as unit.

2. The drive system of claim 1, wherein the housing is elongated in the upright direction to receive the drive train therein.

3. The drive system of claim 2, wherein the housing comprising an upper opening for receiving the drive train into the housing.

4. The drive system of claim 1, wherein the servo motor is rigidly attached to the mounting member with a mounting structure extending from the mounting member to the servo motor.

5. The drive system of claim 4, further comprising a drive shaft extending between the drive head and the servo motor.

6. The drive system of claim 5, further comprising a gear assembly interposed between the drive shaft and the servo motor.

7. The drive system of claim 6, wherein the gear assembly is attached to the drive shaft with a coupling that accommodates misalignment between the gear assembly and the drive shaft.

8. The drive system of claim 5, wherein the drive train includes a bearing assembly positioned between the driveshaft and the mounting structure.

9. The drive system of claim 8, wherein the bearing assembly comprises two spaced apart bearings.

10. The drive system of claim 9, wherein the bearings comprise radial thrust bearings.

11. The drive system of claim 2, wherein the housing is generally in the form of an upright cylinder.

12. The drive system of claim 1, wherein the drive head is adapted to receive at least one indexing wheel shaped to feed containers to the processing station and remove containers from the processing station.

13. The drive system of claim 12, wherein the indexing wheel includes pockets for receiving the containers to be fed to the processing station and from receiving containers for removal from the processing station.

14. The drive system of claim 1, further comprising a control system for controlling the operation of the servo motor to rotate the drive head in a desired direction and at a desired speed.

15. A drive train constructed as a singular unit for powering a work piece transfer system, the drive train comprising:
a rotatable drive head;
a servo motor;
a drive shaft linking the drive head to the servo motor;
a mounting member for mounting the drive train to an operating location of the drive train; and
a rigid mounting structure for mounting the servo motor to the mounting member.

16. The drive train of claim 15, further comprising a gear assembly interposed between the drive shaft and the servo motor.

17. The drive train of claim 15, further comprising at least one bearing assembly interposed between the drive shaft and the mounting structure.

18. The drive train of claim 15, wherein the drive head is configured to be connected to at least one star wheel configured for receiving and transferring work pieces.

19. The drive train of claim 15, adapted for connection to a control system for controlling the operation of the servo motor to rotate the drive head in a desired direction and at a desired speed.
